(19) United States
(12) Patent Application Publication
(10) Pub. No.: US 2025/0257243 A1
(43) Pub. Date: Aug. 14, 2025

(54) PIVOTING FROM FULLY TRANSPARENT ADHESIVE TAPE OR FULLY TRANSLUCENT ADHESIVE TAPE (FTPAToFTLAT) TO MOSTLY TRANSPARENT ADHESIVE TAPE OR MOSTLY TRANSLUCENT ADHESIVE TAPE (MTPAToMTLAT) INORDER TO PIN POINT THE EXACT LOCATION OF THE MTPAToMTLAT's END/BREAK REMAINING ON THE ROLL OF MTPAToMTLAT FOLLOWING THE LATEST TEAR

(71) Applicant: Robert Alan Bard, Barnegat, NJ (US)

(72) Inventor: Robert Alan Bard, Barnegat, NJ (US)

(21) Appl. No.: 18/831,230

(22) Filed: Oct. 2, 2024

Related U.S. Application Data
(60) Provisional application No. 63/629,247, filed on Oct. 4, 2023.

(51) Int. Cl. C09J 7/20

(52) U.S. Cl. CPC C09J 7/203; C09J 2301/122; C09J 2301/16; C09J 2301/30

(57) ABSTRACT

Fully transparent or translucent adhesive tape has been used for many years to wrap packages. Many times following the removal of a portion of the subject tapes from the rolls of the subject tapes the portions of the subject tapes that have not been removed from the subject tapes become re-attached to the rolls of the subject tapes. When the foregoing happens it becomes necessary that before the next use of the subject tapes that a person be able to remove the next portion of the subject tapes remaining on the roll of the subject tapes from the rolls of the subject tapes. This invention, by providing a marking system to help find the end of the subject tape remaining on a roll of mostly transparent or mostly translucent type tape, helps to accomplish the first step in the removal process.

### PRIORITY AND RELATED APPLICATIONS

The present invention claims priority from the U.S. Provisional Patent Application No. 63/629,247 filed on Oct. 4, 2023 entitled A FURTHER IMPROVEMENT TO U.S. patent application Ser. No. 17/300,557 AND Ser. No. 17/300,880 BY VARYING THE WIDTH OF THE “TELLTALE” LINE ALL ALONG THE ENTIRE LENGTH OF THE “TELLTALE” LINE and the U.S. Provisional Patent Application No. 63/655,666 filed on Aug. 7, 2024 entitled LOCATING THE ACTUAL END OF TRANSPARENT/TRANSLUCENT ADHESIVE TAPE (T/TAT) ON A ROLL OF T/TAT FOLLOWING EACH AND EVERY REMOVAL OF T/TAT FROM THE ROLL OF T/TAT. Other than the foregoing provisional patent applications there is no evidence specifically relating to FTPAToFTLAT where there has ever been an attempt to locate the actual end of FTPAToFTLTAT remaining on/attached to a roll of FTPoFTLAT following each and every removal of a portion of T/TAT from a roll of T/TAT.

### BACKGROUND OF THE INVENTION

FTPAToFTLAT has been used for many years for various purposes such as wrapping packages. In many cases, following the removal of a portion of FTPAToFTLAT from a roll of FTPAToFTLAT the end of the portion of FTPAToFTLAT that has not been removed from the roll of FTPAToFTLAT becomes re-attached to the roll of FTPAToFTLAT because of the adhesiveness of the FTPAToFTLAT. When the foregoing happens it becomes necessary before the next use of the FTPAToFTLAT to detach that re-attached end of the FTPAToFTLAT from the roll of FTPAToFTLAT roll of FTPatoFTLAT as easily as possible. This invention, by providing a marking system that pin points the location of the actual end of the portion of the MTPAToMTLAT that became re-attached to the roll of MTPAToMTLAT thus accomplishes the first step in the process of removing the next portion of the of the MTPAToMTLAT that previously became re-attached to the roll of MTPAToMTLAT.

### SUMMARY OF THE INVENTION

This invention is the very first invention that employs a marking system that serves to locate the actual end of the MTPAToMTLAT remaining on/attached to the roll of MTPAToMTLAT following the removal of the previous portion of the MTPAToMTLAT from the roll of MTPAToMTLAT. More specifically, this invention employs a visual indicator line (VIL) that continually varies in width separate from the VIL continuously varying in position relative to the sides of the MTPAToMTLAT all along the entire length of the MTPATOMTLAT with the result being that, statistically, the chance that the VIL on the outermost layer of the MTPAToMTLAT will match/align with the VIL on the layer of the MTPAToMTLAT immediately below the outermost layer of the MTPAToMTLAT will be extremely remote thus locating points on the tear line of the MTPAToMTLAT to in turn enable the start of the peeling off process to remove additional portions of the MTPAToMTLAT for activities such as the packing up boxes of items. Additionally, in concert with the foregoing, the VIL continually varies in position within the confines of an opaque colored band (OCB) that has one side coincident with the side of the MTPAToMTLAT such that both the VIL and the OCB in which the VIL is located are positioned all along the entire length of the MTPAToMTLAT. Furthermore, the width of the OCB itself also continually varies all along the entire length of the MTPAToMLTAT. Of course, the side of the OCB which is not coincident with the side of the MTPAToMTLAT can also be non-varying in its position on the MTPAToMTLAT along the entire length of the MTPAToMTLAT. The combination of all of the foregoing design features statistically insures that there will continually be a misalignment between what is showing on the outermost layer of the MTPAToMTLAT and what is showing on the layer of the MTPAToMTLAT that lies immediately below the outermost layer of the MTPAToMTLAT such that, again where the foregoing misalignment occurs locates points on the tear line of the MTPAToMTLAT thus serving to guide a person towards the tear line which helps to overcome the personal frustration, wasted material and wasted time associated with attempting to first locate the tear line which is necessary before being able to remove additional portions of the MTPAToMTLAT from the roll of MTPAToMTLAT.

### BRIEF DESCRIPTION OF THE DRAWING

FIG. 1 shows two views of rolls of MTPAToMTLAT (!) one view (2) where a portion of the MTPAToMTLAT (1) is partially unfurled from the roll of MTPAToMTLAT (1) and the other view (3) with that same portion of the MTPAToMTLAT (1) that was previously unfurled from the roll of MTPAToMTLAT (1) now re-attached to the roll of MTPAToMTLAT (1). View (2) shows a single VIL (4) whereas view (3) appears to show that what in actual reality is a single VIL (4) now appearing to be the misaligned ends of two separate lines with both lines continuing to be varying in position on the MTPAToMTLAT (1) as well as continuing to be varying in width along the entire length of the MTPAToMTLAT (1). Also, the VIL (4) continues to be located within the continuing variable width of the OCB (5) (shown as hatched) on the roll of MTPAToMTLAT (1). The fully transparent or translucent part of the invention is identified as (6). All of the foregoing has occurred as a result of the above mentioned variations combined with the physical tearing of the MTPAToMTLAT (1) which has also caused the ends of the both of the two lines as well as parts of the OCB (5) to lie on the tear line (7). Of course, the side of the OCB (5) which is not coincident with the side of the MTPAToMTLAT (1) can also be non-varying in its position on the MTPAToMTLAT (1) along the entire length of the MTPAToMTLAT (1).

### DETAILED DESCRIPTION OF THE INVENTION

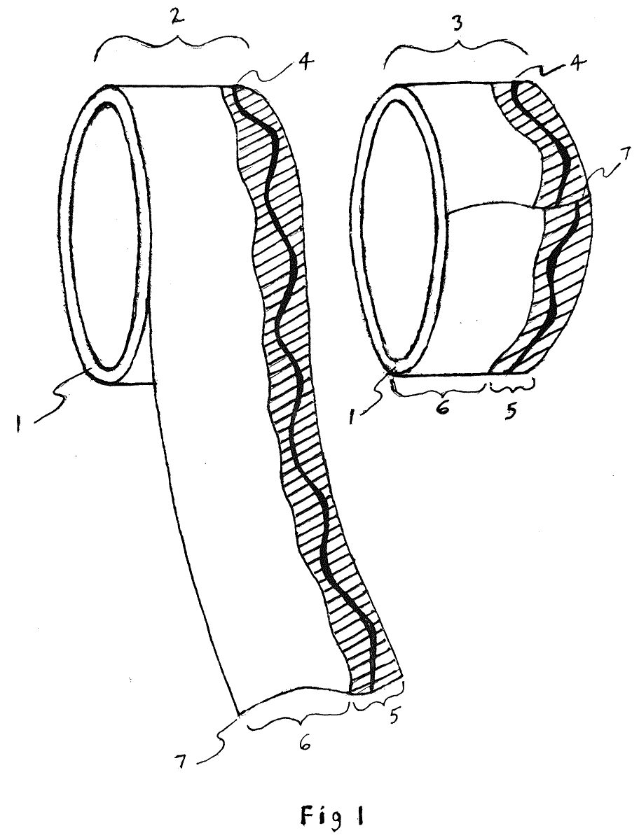

As shown in FIG. 1 this invention employs a VIL (4) that is a line that continuously varies in width separate from continuously varying in position relative to the sides of the MTPAToMTLAT (1) and extending the entire length of the MTPAToMTLAT (1) in addition to the fact that the VIL (4) is also located within an OCB (5) one side of which is coincident with one side edge of the MTPAToMTLAT (1) with OCB (5) also having a width that is continuously varying along the entire length of the MTPAToMTLAT (1). Of course, the side of the OCB (5) which is not coincident with the side of the MTPAToMTLAT (1) can also be non-varying in its position on the MTPAToMTLAT (1) along the entire length of the MTPAToMTLAT (1). The OCB (5) is planned, in actuality, to be a lighter color than the VIL (4) which will also be shown in a darker color in order to contrast the VIL (4) from the color of the OCB (5). The OCB (5) itself, will be dark enough in color to mostly obscure the portion of the OCB (5) underlying the outermost layer of the MTPAToMTLAT (1) as well as the VIL (4) lying within the underlying OCB (5). The foregoing is at the heart of the invention as follows: the invention's continuous variable positioning of the VIL (4) relative to the sides of the MTPAToMTLAT (1) combined with the invention's continuous variable width of the VIL (4) has caused what appears to be not only the ends of two separate VILs (4) misaligned with each other as well as at the same time what appears to be the ends of two separate VILs (4) having two different widths. In actuality, only one of the two VILs (4) has its actual end showing. The false appearance of the end of the other VIL (4) is basically an illusion, however, it is the combination of the occurrence of the misalignment of the two VILs (4) along with the difference in the widths of the two VILs (4) that yields the fact that both the actual end of the VIL (4) as well as the illusionary end of the VIL (4) lie on the actual tear line (7) of the MTPAToMTLAT (1) because the tear itself, has caused what is happening relative to the VIL (4) and thus yielding where to initiate the process of the removal of the next portion of the MTPAToMTLAT (1) from the roll of MTPAToMTLAT (1). Bottom line: it is the tear itself combined with the foregoing variables that are basic to the invention.

Additionally, the invention has been specifically designed to have the VIL (4) located within the OCB (5) which, in turn, also has specifically been designed to have one of the OCB's (5) sides coincident with the side edge of the MTPAToMTLAT (1). for the following reason: it is well known that the locations on the MTPAToMTLAT (1) where it is the easiest to peel off portions of the MTPAToMTLAT (1) from the roll of MTPAToMTLAT (1) is at the side edges of the MTPAToMTLAT (1) because at the side edges of the MTPAToMTLAT (1) the resistive adhesive forces only exist on one side of the item attempting to remove a portion of the MTPAToMTLAT (1) from the roll of MTPAToMTLAT (1) versus at all other areas of the MTPAToMTLAT (1) being where the resistive adhesive forces exist on both sides of the item which is attempting to remove a portion of the MTPAToMTLAT (1) from a roll of MTPAToMTLAT (1). In other words, other than at the side edges of the MTPAToMTLAT, (1) the resistance forces to the removal of a portion of the MtPATOMTLAT (1) from the roll of MTPAToMTLAT (1) are double the resistance for side edges of the MtPAToMtLAT (1). Furthermore, with the side edge of the OCB (5) being coincident with the side edge of the MTPAToMTLAT (1) and with the VIL (4) lying within the OCB (5) consequently the VIL (4) remains generally close to the side edge of the MTPAToMTLAT (1), thus making it easier to align the real and virtual breaks, both of which lie on the actual tear line (7) to optimally, be at a location close to the side edge of the MTPAToMTLAT (1) which in view of the foregoing, is the best location for initiating the peeling process, that location being at the point where the tear intersects the side edge of the MTPAToMTLAT (1) as previously mentioned.

Also incorporated in the design of this invention, is the option to have the side of the OCB (5) that continuously varies in distance from the fixed side of the MTPAToMTLAT (1) be perforated and thus able to be detached from the fully transparent or translucent portion of the MTPAToMTLAT (1) after the marking system has been employed to locate where the tear is located, if there is a need for the MTPAToMTLAT (1) to be fully transparent or fully translucent.

It is also worth noting that, although a continuous VIL (4) is necessary/optimal for locating the tear, it is possible to have unplanned/unintentional breaks or gaps in the VIL (4) throughout the roll of MTPAToMTLAT (1) thus creating a distraction as well as a loss of time in the search for the true end of the MTPAToMTLAT (1) because of the resultant “false” tear points. The foregoing has been herein addressed to hopefully prevent a less accurate solution from being patented and marketed. In addition, it should also be noted that the OCB (5) can provide an effective way to frame writing and/or labels when taping a package thus creating a very significantly noticeable border.

The invention claimed is:

1. A marking system for locating the actual end of MTPAToMTLAT remaining on a roll of MTPAToMTLAT following each and every removal of a portion of MTPAToMTLAT from the roll of MTPAToMTLAT comprising:
a. Providing a VIL on the MTPAToMTLAT, the VIL comprising a single line with a continuously varying width along the entire length of the MTPAToMTLAT in addition to the VIL also continually varying in the VIL's distance from the sides of the MTPAToMTLAT statistically causing several misalignment points between what appears as the end of two lines but because of the physical nature of the situation being that there is only one single VIL, the end of one of the lines is the actual end of the VIL versus the end of the other line being only the virtual/illusionary end of the VIL, however, also because of the physical nature of the situation, the common factor being that the ends of both of the lines lie on the tear line because it is the tear itself, combined with the invention's variables that help in the process of locating the tear.
b. Positioning the VIL within an OCB one side of which coincides with one side of the MTPAToMTLAT such that the OCB is of a lighter color than the VIL but also of a color that is dark enough to mostly obscure the immediate underlying layer of the MTPAToMTLAT where the VIL lies separate from the fact that the other side of the OCB which is not coincident with the side of the MTPAToMTLAT continually varies in distance from the side of MTPAToMTLAT. Of course, the side of the OCB which is not coincident with the side of the MTPAToMTLAT can also be non-varying in its position on the MTPAToMTLAT along the entire length of the MTPAToMTLAT. The foregoing yields the same results as what has been described in (a) above that, again because of statistics, several additional points end up lying on the actual tear line. It is important to note that the additional advantage of the VIL being entirely located within the OCB which has one side which coincides with the side edge of the MTPAToMTLAT is that, in terms of the best/easiest place to begin peeling MTPAToMTLAT from the roll of MTPAToMTLAT is at the side edge of the MTPAToMTLAT, because that is where the resistive adhesive forces are most reduced in turn because at the side edge of the MTPAToMTLAT, the restive adhesive forces exist on only one side of the item attempting to remove a portion of MTPAToMTLAT from the roll of MTPAToMTLAT whereas elsewhere on the MTPAToMTLAT resistive adhesive forces act on both sides of the item attempting to remove a portion of the MTPAToMTLAT from the roll of MTPAToMTLTAT.
c. Incorporating the option to have the side of the OCB that continuously varies in distance from the side of the MTPAToMTLAT be perforated and thus detachable from the rest of the MTPAToMTLAT, so that after the tear is located, any need for full transparency or full translucence can be satisfied.
